(19) United States
(12) Patent Application Publication
(10) Pub. No.: US 2024/0202843 A1
(43) Pub. Date: Jun. 20, 2024

(54) WIRELESS CHARGING AUTHENTICATION AND PAYMENT SYSTEM

(71) Applicant: VETUREX INC, Dubai (AE)

(72) Inventors: Cengiz Hakan KUTLUHAN, Erlangen (DE); Omer Faruk YERLI, Frankfurt am Main (DE)

(21) Appl. No.: 18/067,836

(22) Filed: Dec. 19, 2022

(51) Int. Cl. G06Q 50/06; B60L 53/62; G06Q 20/22; G06Q 20/38; G06Q 20/40; H02J 7/00; H02J 50/10

(52) U.S. Cl. CPC G06Q 50/06; B60L 53/62; G06Q 20/223; G06Q 20/389; G06Q 20/40; H02J 7/00045; H02J 50/10; B60L 53/12

(57) ABSTRACT

A wireless charging authentication and payment system includes an electronic device configured for wirelessly receiving electromagnetic energy in accordance with a charge request to charge a battery of the electronic device, and an energy supply device configured to supply the electromagnetic energy for wirelessly charging the electronic device according to the charge request. The system also includes an electronic controller configured to receive the charge request and to transmit the charging command to the energy supply device to wirelessly supply the electromagnetic energy to the electronic device according to the charge request. The electronic controller further is configured to process a payment for the electromagnetic energy that is supplied by the energy supply device and received by the electronic device for wirelessly charging the battery of the electronic device.

### FIELD OF INVENTION

The present application relates generally to wireless charging of electronic devices. For example, the present application is principally directed toward wireless charging of electric vehicles, although comparable principles may be applied to wireless charging of various types of electronic devices. The wireless charging principles of the present application particularly are suited to charging from a first electric vehicle to a second electric vehicle positioned bumper to bumper.

### BACKGROUND OF THE INVENTION

The battery charging of an electronic device, while seeming simple at first consideration, often is not actually just a matter of plugging the electronic device into a power supply. The electronic device being charged and the power supply or charging point device need to be able to electrically communicate. There can be both operational and physical impediments to such communication. First, the electronic device being charged and the charging device need to communicate through a compatible language pertaining to operational protocols, such as available charging modes and/or electric power compatibility as to parameters such as operational voltage and current levels. In addition, there often has to be a physical connection between the electronic device being charged and the charging device via a charging cable. Different manufactures, however, may employ different configurations of the physical electrical connector components, which may preclude charging an electronic device using a charging device made by a different manufacturer. Physical electrical connector configurations also can vary across international regions.

Compatibility issues in particular remain an issue in connection with the charging of the batteries of electric vehicles (EVs). The charging mode basically determines how quickly the vehicle battery can be charged depending upon the capabilities of the charging point device or charging station. When it comes to the charging cable for operating the various charging modes, there are numerous different connector types, which can differ depending upon the particular vehicle manufacturer, the geographic region, and/or whether one is using a commercial charging point or charging station versus a home domestic electricity power supply. Four types of electric charging connectors are common for EVs, including two types common for AC charging (Types 1 and 2) and two types common for DC charging (CHAdeMo and CCS). Type 1 is common for U.S. vehicles and includes a single-phase plug that can charge at a speed of up to 7.4 KW. Type 2 is standard for European and Asian vehicles from 2018 onwards and includes a triple-phase plug that can charge at a level of up to 43 KW. CCS is a version of Type 2 with two additional power contacts that allows for very fast charging. CHAdeMO can be found in Asian cars and allows for high charging capacities as well as bidirectional charging between two devices, for example charging a first EV by a second EV. It is rare to find all four charging connector types in the same charging station unit, and/or in the same EV.

While the popularity of EVs is growing and standardization of connector types is improving, the physical connection between an EV and the charging point or charging station is still a major disadvantage to owning an EV. Comparable physical compatibility issues may arise in various other fields of electronic devices. For example, portable electronic communication and computer devices (e.g., smart phones, tablets, laptops, and the like) are known to have charging equipment that differs from one manufacturer to another manufacturer. One manner of overcoming the compatibility issues associated with physical electrical connectors is to employ wireless charging whereby electromagnetic energy is transmitted across an air gap from the charging device to the device being charged, and the device being charged converts the received electromagnetic energy into a usable form of electrical energy for charging the battery. Although wireless charging systems are being developed, such systems continue to have deficiencies, and in particular a suitable wireless charging system for EVs has been difficult to achieve.

Moreover, providing energy to EVs currently is built in a form of a closed system in which usage is limited to particular users or vehicles that may part of a membership or comparable type of categorical system. EV charging often is governed by electronic applications, or more commonly known in layperson terms as “apps”, which may be incorporated into electronic components of the vehicle and charging system, as well as present on mobile devices that can be linked to an EV or charging system. In conventional charging systems, the electronic applications for providing energy to EVs that exist today typically are made by the charging station owners, and their charging stations or charging units are only shared in their particular apps. If one is not a member or has an account tied to the specific manufacturer's charging station, one cannot implement charging from that charging station through that manufacturer's app. The result is a complex network of isolated charging systems, whereby users need accounts with various charging app providers to ensure adequate access to the respective charging stations.

In addition, because charging apps tend to be linked to charging station owners, the need for access to a charging station can be limiting. In particular, it would be desirable to have a charging protocol that is suited to charging from a first EV to a second EV that are positioned adjacent to each other, such as the vehicles being positioned bumper to bumper. Such a system would permit urgent charging in a peer-to-peer vehicle transfer of energy between the two vehicles. A peer-to-peer capability between two vehicles by wireless energy transfer provides a universal charging protocol that supplements standard charging systems when physical connections and/or electronic app access may be incompatible.

### SUMMARY OF INVENTION

A wireless charging authentication and payment system, method and related non-transitory computer readable medium are described. The system ensures that electronic devices, such as electric vehicles (EVs), can access the charging stations that are the most suitable for their type without the need for membership, with the capability to make payments online or otherwise via a computer based network. In addition, the wireless charging authentication and payment system allows the peer-to-peer transfer of energy from a first electronic device to a second electronic device, for example from a first EV to a second EV, facilitating access to energy at any point and allowing users to earn income with the smart use of energy. Because this hardware of the system employs wireless energy transfer technology without any physical connection, the system protocol makes every charging station and EV a potential energy provider.

An aspect of the invention, therefore, is a wireless charging authentication and payment system that includes an electronic device configured for wirelessly receiving electromagnetic energy in accordance with a charge request to charge a battery of the electronic device, and an energy supply device configured to supply the electromagnetic energy for wirelessly charging the electronic device according to the charge request. The system also includes an electronic controller configured to receive the charge request and to transmit a charging command to the energy supply device to wirelessly supply the electromagnetic energy to the electronic device according to the charge request. The electronic controller further is configured to process a payment for the electromagnetic energy that is supplied by the energy supply device and received by the electronic device for wirelessly charging the battery of the electronic device.

In exemplary embodiments of the wireless charging authentication and payment system, the electronic controller is a cloud server located remotely from the electronic device and the energy supply device. The energy supply device includes an energy supply device wireless communication module, and the electronic device includes an electronic device wireless communication module. The energy supply device wireless communication module and the electronic device wireless communication module are configured to wirelessly communicate with the cloud server to implement the charge request and to process the payment. The energy supply device wireless communication module and the electronic device wireless communication module further may be configured to wirelessly communicate with each other to pair the energy supply device with the electronic device to implement the charge request.

Another aspect of the invention is a method of wireless charging authentication and payment that includes the steps of pairing an electronic device with an energy supply device, and generating a charge request for wirelessly supplying electromagnetic energy from the energy supply device to the electronic device to charge a battery of the electronic device. The method further includes the step of receiving, by an electronic controller, the charge request. The method further includes the step of commanding, with the electronic controller, the energy supply device to wirelessly supply the electromagnetic energy to the electronic device to charge the battery of the electronic device, according to the charge request. The method further includes the step of identifying, with the electronic controller, when the charge request is satisfied. The method further includes the step of commanding, with the electronic controller, the energy supply device to stop wirelessly supplying the electromagnetic energy to the electronic device when the charge request is satisfied. The method further includes the step of processing a payment, with the electronic controller, for the electromagnetic energy that is supplied by the energy supply device to charge the battery of the electronic device, according to the charge request.

Another aspect of the invention is a non-transitory computer readable medium that stores executable program code, which when executed by a computer performs the method.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a schematic diagram of an exemplary wireless charging authentication and payment system, according to an aspect of the present disclosure.

FIG. 2 is a drawing depicting a flowchart of an exemplary method of wireless charging authentication and payment, according to another aspect of the present disclosure.

FIG. 3 is a drawing depicting an exemplary peer-to-peer wireless transfer of energy from a first electric vehicle to a second electric vehicle.

FIG. 4 is a drawing depicting an exemplary wireless transfer of energy from a wireless charging panel of a power supply device to an electronic vehicle.

### DETAILED DESCRIPTION

Embodiments of the present application will now be described with reference to the drawings, wherein like reference numerals are used to refer to like elements throughout. It will be understood that the figures are not necessarily to scale.

A wireless charging authentication and payment system is disclosed. The wireless charging authentication and payment system is configured to facilitate wireless charging of an electronic device, such as an electronic vehicle (EV), by an energy supply device. The energy supply device may be, for example, a wireless charging station or another electronic device (such as another EV), such that one electronic device may be used to wirelessly charge another electronic device. The wireless charging authentication and payment system is also configured to process payment of the wireless charging when the wireless charging is completed. Specifically, when the electronic device approaches the energy supply device, the electronic device is configured to wirelessly pair with the energy supply device. Once paired, a charge request is made that is received by an electronic controller, and based on the charge request, the electronic controller transmits a charging command to the energy supply device to wirelessly charge the electronic device to satisfy the charge request. Once the charge request is satisfied and the charging is completed, the electronic controller processes a payment for the wireless charging from the electronic device to the energy supply device. In exemplary embodiments, the electronic controller is a cloud server that is configured for wireless communication with the energy supply device and the electronic device being charged.

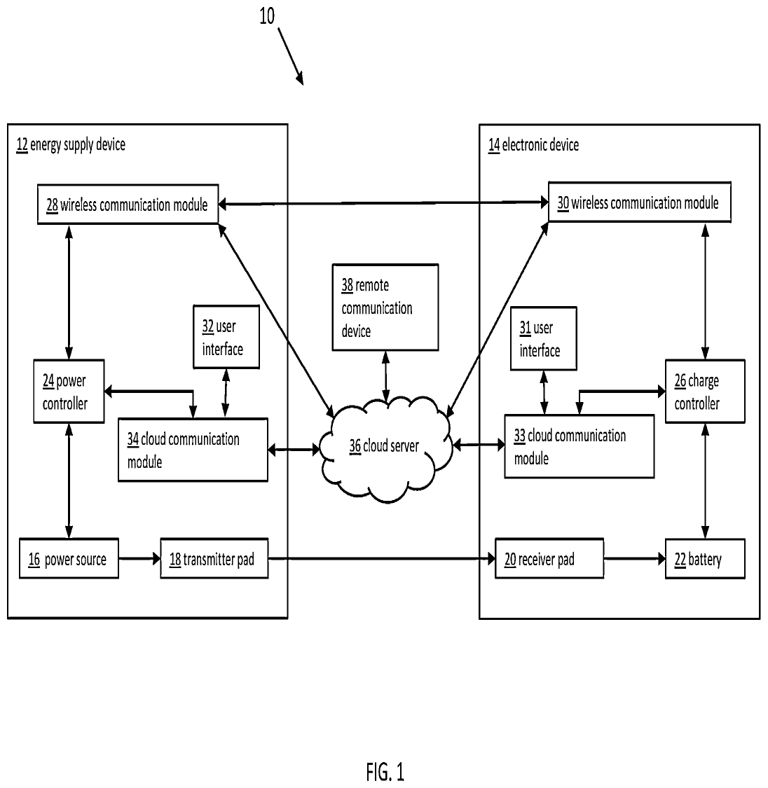

FIG. 1 is a drawing depicting a schematic block diagram of operative portions of an exemplary wireless charging authentication and payment system 10 in accordance with embodiments of the present disclosure. The system 10 includes an energy supply device 12 and an electronic device 14. The energy supply device 12 is configured to supply electromagnetic energy to the electronic device 14 for wirelessly charging a battery 22 of the electronic device 14 according to a charge request. The electronic device 14 is therefore configured to wirelessly receive the electromagnetic energy from the energy supply device 12 to charge the battery 22 of the electronic device 14 according to the charge request. The system 10 also includes an electronic controller 36 configured to receive the charge request and to command the energy supply device 12 to wirelessly supply the electromagnetic energy to the electronic device 14 according to the charge request. The electronic controller 36 is further configured to process a payment for the electromagnetic energy that is supplied by the energy supply device 12 and received by the electronic device 14 for wirelessly charging the battery 22 of the electronic device.

In the embodiment depicted in FIG. 1, the electronic controller 36 is a cloud server located remotely from the electronic device 14 and the energy supply device 12. It is understood, however, that the electronic controller 36 may be located elsewhere, such as on the energy supply device 12, the electronic device 14, or in another device located remotely from the electronic device 14 and the energy supply device 12. A system including a centrally accessed electronic controller, and a cloud-based server controller as an exemplary implementation, in particular permits broader or universal access, whereby various types of charging stations and electronic devices, such as various EVs and EV charging stations, can participate through a centralized charging system. In this manner, previous limitations resulting from different manufacturer electrical connector configurations and charging protocols are eliminated.

The energy supply device 12 includes a power source 16 configured to supply power that is to be transmitted as the electromagnetic energy, and a transmitter pad 18 for wirelessly transmitting the electromagnetic energy. The electronic device 14 includes a complementary receiver pad 20 for wirelessly receiving the electromagnetic energy from the transmitter pad 18 of the energy supply device 12, and the battery 22 of the electronic device 14 is configured to store the electromagnetic energy as power. The energy supply device 12 includes a power controller 24 configured to identify and control an amount of power that is being supplied by the power source 16. Similarly, the electronic device 14 includes a charge controller 26 configured to identify and control the amount of power that is stored in the battery 22.

The energy supply device 12 includes an energy supply device wireless communication module 28, and the electronic device 14 includes an electronic device wireless communication module 30. The energy supply device wireless communication module 28 and the electronic device wireless communication module 30 are each configured to wirelessly communicate with each other, such that when the electronic device 14 approaches the energy supply device 12, the electronic device wireless communication module 30 is configured to communicate with the energy supply device wireless communication module 28 to pair the electronic device 14 with the energy supply device 12. Electronic pairing may be performed using any suitable electronic pairing as is known in the art of electronic devices. One example pairing may include the exchange of electronic keys whereby system energy supply devices and system electronic devices can recognize each other automatically based on proximity for wireless charging. The authentication system permits a secure exchange of identity information between energy supply devices and electronic devices that participate in the system, thus overcoming current limitations based on individual manufacturer and supplier apps.

The energy supply device wireless communication module 28 and the electronic device wireless communication module 30 are also configured to communicate wirelessly with the electronic controller 36 (e.g., the cloud server). For example, the electronic device wireless communication module 30 and the energy supply device wireless communication module 28 may wirelessly communicate with each other and the electronic controller 36 with Bluetooth technology, WiFi technology, cellular technology, or any other suitable wireless communication technology.

Once the energy supply device 12 and the electronic device 14 are paired, a charge request is made and communicated to the electronic controller 36, and the electronic controller 36 transmits a charging command to the energy supply device 12 for wirelessly charging the electronic device 14. The charge request dictates an amount of power that is to be supplied by the power source 16 for wirelessly charging the electronic device 14. The charge request may indicate either an amount of power that should be supplied by the power source 16, or a period of time that the power source 14 should supply power. For example, the charge request may indicate an amount of power that should be supplied by the power source 16 to wirelessly charge the battery 22 of the electronic device 14 so that the battery 22 reaches a predetermined battery power capacity, such as full battery power capacity. Alternatively, the charge request may indicate an amount of time that the power source 16 should supply power to wirelessly charge the electronic device 14.

In one embodiment, the charge controller 26 of the electronic device 14 may be configured to identify how much power currently is stored in the battery 22 of the electronic device 14, and the charge controller 26 is configured to generate the charge request based on how much power is needed to charge the battery 22 to the predetermined battery power capacity, such as the full battery capacity. The charge controller 26 is then configured to communicate the charge request to the electronic controller 36, and the electronic controller 36 is configured to transmit a charging command to the power controller 24 of the energy supply device 12 which commands the power controller 24 to supply power according to the charge request. In the exemplary embodiment in which the electronic controller 36 is the cloud server, the charge controller 26 is configured to communicate the charge request to the cloud server 36 via an electronic device cloud communication module 33, and the cloud server 36 is configured to transmit the charging command to the power controller 24 of the energy supply device 12 via an energy supply device cloud communication module 34. Otherwise, the charge controller 26 may be configured to communicate the charge request to the electronic controller 36 via the electronic device wireless communications module 30, and the electronic device 36 may be configured to transmit the charging command to the power controller 24 via the energy supply device wireless communication module 28. It will be appreciated that the communication modules 28/34 of the energy supply device 12 may be integrated components for wireless communication rather than separate components. Similarly, it will be appreciated that the communication modules 30/33 of the electronic device 14 may be integrated components for wireless communication rather than separate components. Accordingly, any implementation of separate or combined communication modules may be employed for wireless communication, and thus although the communication modules are depicted as separate components, such depiction is for ease of illustration and non-limiting. A wireless communication module may include any suitable antenna and processing circuitry for wireless communication in accordance with any suitable wireless communication technology as referenced above.

In another embodiment, the electronic device 14 may include an electronic device user interface 31, and the charge request may be made by a user inputting the charge request into the electronic device user interface 31. Similarly, the energy supply device 12 may include an energy supply device user interface 32, and the charge request may be made by a user inputting the charge request into the energy supply device user interface 32. The electronic device user interface 31 and the energy supply device user interface 32 are then configured to communicate the inputted charge request to the electronic controller 36, and the electronic controller 36 is configured to transmit a charging command to the power controller 24 of the energy supply device 12 for wirelessly charging the electronic device 14 according to the charge request. In the exemplary embodiment in which the electronic controller 36 is the cloud server, the electronic device user interface 31 and the energy supply device user interface 32 are respectively configured to communicate the charge request to the cloud server 36 via the respective associated electronic device cloud communication module 33 and the energy supply device cloud communication module 34, and the cloud server 36 is configured to transmit the charging command to the power controller 24 via the energy supply device cloud communication module 34. Otherwise, the electronic device user interface 31 and the energy supply device user interface 32 may be respectively configured to communicate the charge request to the electronic controller 36 via the respective associated electronic device wireless communications module 30 and energy supply device wireless communication module 28, and the electronic device 36 may be configured to transmit the charging command to the power controller 24 via the energy supply device wireless communication module 28.

In yet another embodiment, the charge request may be inputted into a mobile application on a remote communication device 38. The remote communication device 38 may be any suitable electronic communication device, including common portable communications devices such as tablet computers, laptop computers, smartphones, and the like. The mobile application is configured to communicate the charge request to the electronic controller 36, and the electronic controller 36 is configured to transmit the charging command to the power controller 24 of the energy supply device 12. In the embodiment in which the electronic controller 36 is the cloud server, the cloud server 36 is configured to transmit the charging command to the power controller 24 via the energy supply device cloud communication module 34. Otherwise, the electronic controller 36 is configured to transmit the charging command to the power controller 24 via the energy supply device wireless communication module 28.

The power controller 24 is therefore configured to receive the charge request and command the power source 16 to begin supplying power to the transmitter pad 18, according to the charge request. As described earlier, the transmitter pad 18 is configured to transmit the supplied power wirelessly as electromagnetic energy to the receiver pad 20 of the electronic device 14, and the receiver pad 20 is configured to wirelessly receive the electromagnetic energy, which is converted by the electronic device 14 into a suitable form to store the energy by charging the battery 22.

The power controller 24 of the energy supply device 12 may be configured to identify and track the amount of power being supplied by the power source 16 and/or the amount of time that the power source 16 is supplying power, depending on the nature of the charge request. Additionally or alternatively, the charge controller 26 of the electronic device 14 may be configured to identify and track the amount of power being stored in the battery 22 and/or the amount of time that the battery 22 is receiving power, again depending on the nature of the charge request. For example, when the charge request indicates an amount of power that should be supplied by the power source 14, the power controller 24 may be configured to identify and track the amount of power being supplied by the power source 14, and/or the charge controller 26 may be configured to identify and track the amount of power being received by the battery 22. When the charge request indicates a period of time that the power source 14 should supply power, the power controller 24 may be configured to identify and track the amount of time that the power source 16 is supplying power, and/or the charge controller 26 may be configured to identify and track the amount of time that the battery 22 is receiving power.

The power controller 24 and/or the charge controller 26 are then configured to communicate the respective tracked amount of power or tracked amount of time to the electronic controller 36, and the electronic controller 36 is configured to identify when the charge request has been satisfied, based on the respective tracked amount of power or tracked amount of time, to determine when the charge request is satisfied. That is, the electronic controller 36 is configured to identify when the power source 14 has supplied the amount of power indicated by the charge request and/or the battery 22 has received the amount of power indicated by the charge request, or to identify when the amount of time indicated by the charge request for the power source 14 to supply power and/or the battery 22 to receive power, has passed. When the electronic controller 36 identifies that the charge request has been satisfied, the electronic controller 36 transmits a stop command to the power controller 24 and the power controller 24 is configured to command the power source 16 of the energy supply device 12 to stop supplying power. In the embodiment in which the electronic controller 36 is the cloud server, the respective communications are made via the respective cloud communication modules 33, 34, as previously described. Otherwise, the communications may be made via the respective wireless communication modules 28, 30, as previously described.

The electronic controller 36 is configured to store the respective tracked amount of power and/or the respective tracked amount of time to a user profile linked to the electronic device 14. The user profile may also include information about the user's electronic device 14 that is being wirelessly charged and the user's payment information. Therefore, once the wireless charging is completed, the electronic controller 36 is configured to process a payment for the energy that was transferred during the wireless charging according to the charge request. In this manner, an owner for operator of the electronic device being charged provides appropriate payment to the owner or operator of the energy supply device.

The electronic controller 36 may process the payment in a number of ways. In one example, standard payment methods that are used in the art of online payments may be used in the charging system of the current disclosure. Such payment methods, for example, may include credit card payments, electronic bank transfers, and the like from an account of the owner or operator of the electronic device being charged to an account of the owner or operator of the energy supply device. The charging system 10 also may be linked to various third-party payment processors that generally process payments between buyers and sellers as are known in the art (e.g., PayPal®, Venmo® and the like). Payment methods employed by owners or operators of the electronic device, and payment methods that are accepted by the owners or operators of the energy supply device, may be stored in the electronic controller.

More modern or newer technologies for energy transfer and electronic payment also may be employed in the charging system of the current disclosure. In one embodiment, the tracked amount of power or amount of time may be converted to carbon credits equal to the amount of energy consumed. The carbon credits may be tokenized and payment may be processed using the tokenized carbon credits. In another embodiment, payment may be processed using a user's payment information stored in their user profile. In yet another embodiment, payment may be processed by the user inputting their payment information in the mobile application on the remote device 38, which is then communicated to the electronic controller 36. Alternatively, a bill may be automatically created based on the tracked amount of power or amount of time, and the bill may be sent to the user of the electronic device 14 for payment, such as via the remote device 38.

In another embodiment, a peer-to-peer block chain linkage may be created using blockchain technology. In this embodiment, the energy supply device 12 and the electronic device 14 each have a unique key identifier. When the electronic device 14 is paired with the energy supply device 12, the respective keys of the electronic device 14 and the energy supply device 12 are matched and form a block chain in which the wireless charging process and information may be stored. Payment then may be implemented using crypto currency or other suitable means.

To implement the features of the present application, the electronic components of the charging system 10, including the electronic controller/cloud server, the power and charging controllers, the various communication modules, the user interfaces, and any other of electronic components that may be incorporated into the charging system, may be configured is any suitable manner as is known the art of electronic computer-based devices. The electronic components, for example, may include one or more processor devices that are configured to execute program code stored on a non-transitory computer readable medium embodying the control methods and operations associated with the charging system of the present disclosure. It will be apparent to a person having ordinary skill in the art of computer programming of electronic devices how to program the electronic components to operate and carry out logical functions associated with present application. Accordingly, details as to specific programming code have been left out for the sake of brevity. Also, controller and other electronic functionality could be carried out via dedicated hardware, firmware, software, or any combinations thereof, without departing from the scope of the disclosure. As will be understood by one of ordinary skill in the art, therefore, the electronic components may have various implementations. For example, the electronic components may be configured as any suitable processor device(s), such as a programmable circuit, integrated circuit, memory and I/O circuits, an application specific integrated circuit, microcontroller, complex programmable logic device, other programmable circuits, or the like. The electronic components may also include a non-transitory computer readable medium, such as random access memory (RAM), a read-only memory (ROM), an erasable programmable read-only memory (EPROM or Flash memory), or any other suitable medium. Instructions for performing the methods and operations of the current application may be stored in the non-transitory computer readable medium and executed by the processor device or devices.

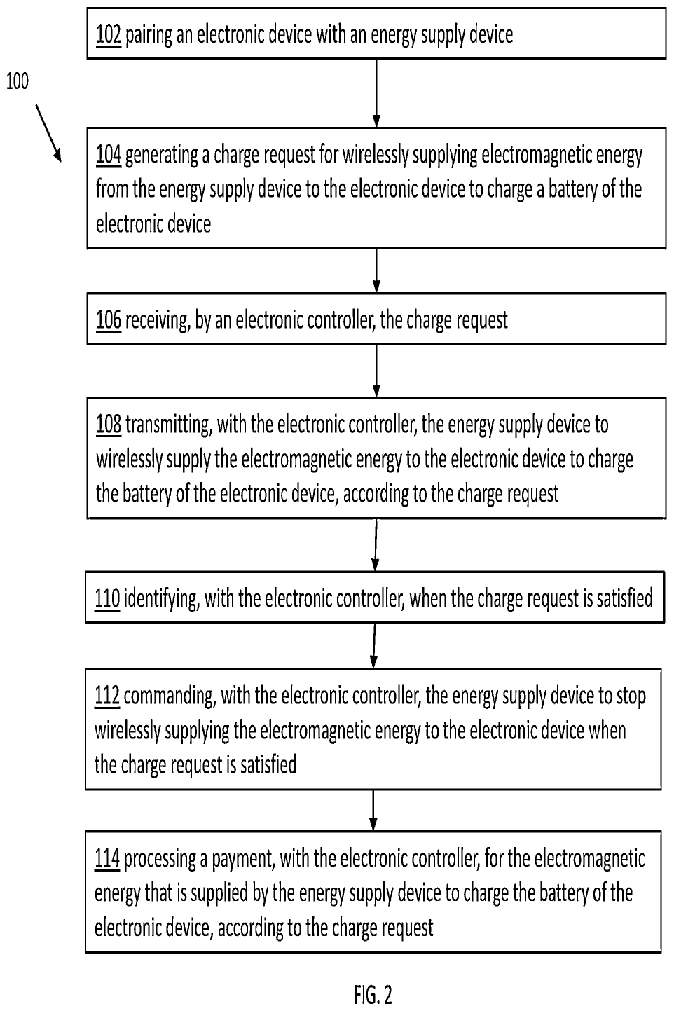

Turning to FIG. 2, a flowchart of a method 100 of wireless charging authentication and payment is depicted. The method 100 may be performed with the wireless charging authentication and payment system 10 described above. The method 100 therefore includes a step 102 of pairing an electronic device (such as the electronic device 14) with an energy supply device (such as the energy supply device 12). The method 100 then includes a step 104 of generating a charge request for wirelessly supplying electromagnetic energy from the energy supply device to the electronic device to charge a battery (such as the battery 22) of the electronic device. The charge request may be generated according to any of the embodiments described above using the wireless charging authentication and payment system 10. For example, generating the charge request may include identifying how much power is stored in the battery of the electronic device and generating the charge request based thereon. Alternatively, generating the charge request may include inputting the charge request in a user interface on the energy supply device (such as the energy supply device user interface 32) and/or in a user interface on the electronic device (such as the electronic device user interface 31). In yet another embodiment, generating the charge request may include inputting the charge request into a mobile application on a remote device (such as the remote communication device 38). In each embodiment, the charge request is communicated to an electronic controller (such as the electronic controller 36).

The method 100 therefore then includes the step 106 of receiving, by the electronic controller, the charge request and a step 108 of transmitting a charging command, with the electronic controller, to the energy supply device to wirelessly supply the electromagnetic energy to the electronic device to charge the battery of the electronic device, according to the charge request. The method 100 the includes a step 110 of identifying, with the electronic controller, when the charge request is satisfied, and a step 112 of commanding, with the electronic controller, the energy supply device to stop wirelessly supplying the electromagnetic energy to the electronic device when the charge request is satisfied.

The method then includes a step 114 of processing a payment, with the electronic controller, for the electromagnetic energy that is supplied by the energy supply device to charge the battery of the electronic device, according to the charge request. The step 114 of processing payment may include converting the electromagnetic energy that is supplied from the energy supply device into carbon credits, tokenizing the carbon credits, and processing the payment with the tokenized carbon credits. Alternatively, the step 114 of processing payment may include using a user's payment information stored in a user profile in the electronic controller, or by a user inputting their payment information in the mobile application on the remote device. In another embodiment, processing payment may include creating a bill based on the tracked amount of power or amount of time and sending the bill to the user. The method 100 may also include a step of tracking, with the electronic controller, the electromagnetic energy that is supplied to the energy supply device in a peer-to-peer block chain for electronic payment, as described above.

Another aspect of the present disclosure is a non-transitory computer readable medium that stores executable program code, which when executed by a computer performs the method 100 described above, according to any of the embodiments. The program code may be executed by one or more electronic components of the wireless charging authentication and payment system 10 described above.

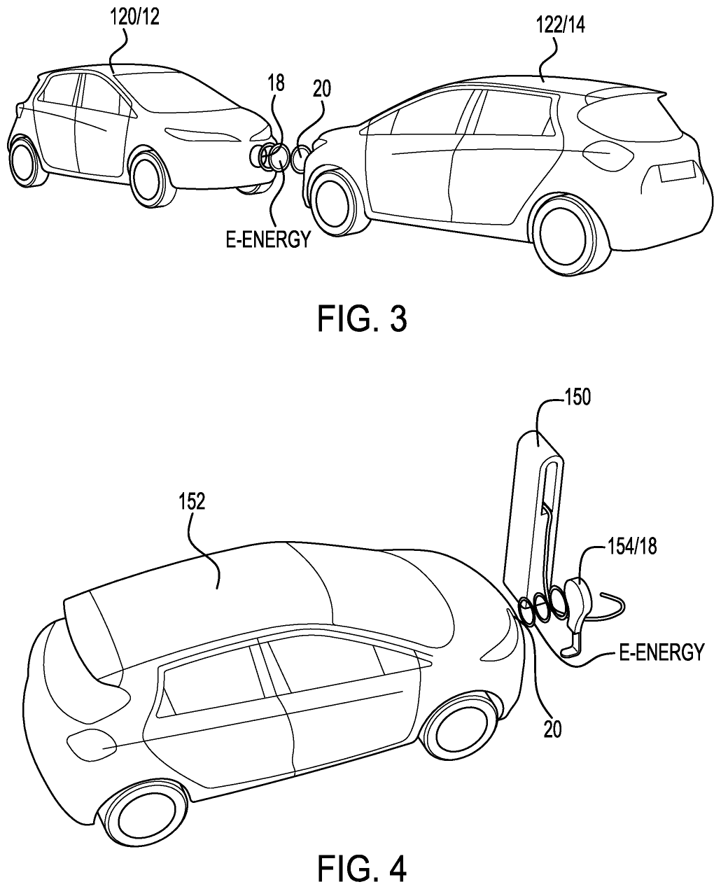

FIG. 3 is a drawing depicting a peer-to-peer transfer of electromagnetic energy, with which one or more aspects of this disclosure may be employed. Specifically, FIG. 3 depicts a wireless transfer of electromagnetic energy from a first EV 120 (representing the energy supply device 12 described above) to a second EV 122 (representing the electronic device 14 described above), with each vehicle having a plug-in module including the respective transmitter pad 18 and receiver pad 20. In the depicted example of FIG. 3, each of the plug-in modules is positioned with connections to the front or hood of each respective EV, and internal connections would run through the EV for connection to the battery pack. A front or hood arrangement provides for convenient positioning of the EVs in a front bumper-to-bumper orientation, although other suitable positions may be employed. For example, rear positioning or side positioning of the plug-in modules may be employed to provide other potential relative EV orientations, such as side-to-side (e.g., if the EVs are in adjacent parking spaces), rear-to-rear bumper if both EVs have a rearward plug-in module positioning, or front bumper to rear bumper if one EV has a front positioned plug-in module and one EV as a rear positioned plug-in module. At times, the first EV 120 may be the energy supply device that uses its own battery power to charge the battery of the second EV 122, while at other times, the second EV 122 may be the energy supply device that uses its own battery power to charge the battery of the first EV 120.

FIG. 4 is a drawing depicting another transfer of energy from an energy supply device 150 to an EV 152, with which one or more aspects of this disclosure may be employed. Specifically, FIG. 4 depicts a wireless transfer of electromagnetic energy from a wireless charging panel 154 of the energy supply device 150 (representing the energy supply device 12 described above) to the EV 152 (representing the electronic device 14 described above). The wireless charging panel 154 has the transmitter pad 18 described above, and the EV 152 has the receiver pad 20 described above. In the depicted example of FIG. 4, the receiver pad 20 would be positioned with connections to the front or hood of the EV 152, and internal connections would run through the EV 152 for connection to the battery pack. A front or hood arrangement provides for convenient positioning of the EV 152 in a front bumper orientation with the wireless charging panel 154/transmitter pad 18, although other suitable positions may be employed. For example, rear positioning or side positioning of the receiver pad 20 may be employed to provide other potential relative EV orientations, such as side (e.g., if the EV 152 is parked with its side facing the wireless charging panel 154/transmitter pad 18), or rear (e.g., if the EV 152 is parked with its rear bumper facing the wireless charging panel 154/transmitter pad 18).

While this disclosure principally describes wireless charging in connection with the charging of EVs, the principles described herein are not limited to that particular charging application. For example, aspects of the present disclosure may be used in a wide variety of other applications such as domestic, engineering, industrial, communications, medical and military environments. Aspects of this disclosure may be used in any suitable setting where the charging of a battery or power source is required.

A wireless charging authentication and payment system includes an electronic device configured for wirelessly receiving electromagnetic energy in accordance with a charge request to charge a battery of the electronic device, and an energy supply device configured to supply the electromagnetic energy for wirelessly charging the electronic device according to the charge request. The system also includes an electronic controller configured to receive the charge request and to transmit a charging command to the energy supply device to wirelessly supply the electromagnetic energy to the electronic device according to the charge request. The electronic controller further is configured to process a payment for the electromagnetic energy that is supplied by the energy supply device and received by the electronic device for wirelessly charging the battery of the electronic device.

The electronic controller may be a cloud server located remotely from the electronic device and the energy supply device. The energy supply device may include an energy supply device wireless communication module and the electronic device may include an electronic device wireless communication module. The energy supply device wireless communication module and the electronic device wireless communication module may be configured to wirelessly communicate with the cloud server.

The energy supply device wireless communication module and the electronic device wireless communication module may be configured to wirelessly communicate with each other to pair the energy supply device with the electronic device.

The energy supply device may include an energy supply device wireless communication module and the electronic device may include an electronic device wireless communication module. The energy supply device wireless communication module and the electronic device wireless communication module may be configured to wirelessly communicate with each other to pair the energy supply device with the electronic device.

The energy supply device may include a power source configured to supply power and a transmitter pad configured to wirelessly transmit the supplied power as the electromagnetic energy to the electronic device. The electronic device may include a receiver pad configured to wirelessly receive the electromagnetic energy transmitted by the transmitter pad, and the battery stores the electromagnetic energy received by the receiver pad.

The energy supply device may include a power controller configured to identify and control an amount of power being supplied by the power source, and the electronic device may include a charge controller configured to identify and control an amount of power stored in the battery.

The charge controller may be configured to generate the charge request based on the amount of power identified as being stored in the battery, and the electronic device may be configured to communicate the charge request to the electronic controller.

At least one of the energy supply device and the electronic device may include a user interface configured to receive the charge request from a user, and the at least one of the energy supply device and the electronic device may be configured to communicate the charge request to the electronic controller.

The energy supply device wireless communication module may be configured to wirelessly receive the charging command from the cloud server.

The wireless charging authentication and payment system may further include a mobile application on a remote communication device configured to receive the charge request from a user and store the charge request in the cloud server.

The electronic controller may be configured to process the payment using tokenized carbon credits.

The electronic controller may be configured to track the electromagnetic energy that is supplied to the energy supply device and received by the electronic device in a peer-to-peer block chain system.

A method of wireless charging authentication and payment includes the steps of pairing an electronic device with an energy supply device and generating a charge request for wirelessly supplying electromagnetic energy from the energy supply device to the electronic device to charge a battery of the electronic device. The method may include the step of receiving, by an electronic controller, the charge request. The method may then include the step of commanding, with the electronic controller, the energy supply device to wirelessly supply the electromagnetic energy to the electronic device to charge the battery of the electronic device, according to the charge request. The method may then include the step of identifying, with the electronic controller, when the charge request is satisfied. The method may then include the step of commanding, with the electronic controller, the energy supply device to stop wirelessly supplying the electromagnetic energy to the electronic device when the charge request is satisfied. The method may then include the step of processing a payment, with the electronic controller, for the electromagnetic energy that is supplied by the energy supply device to charge the battery of the electronic device, according to the charge request.

The step of generating the charge request may include identifying how much power is stored in a battery of the electronic device.

The step of generating the charge request may include inputting the charge request in a user interface on the energy supply device.

The step of generating the charge request may include inputting the charge request in a user interface on the electronic device.

The step of generating the charge request may include inputting the charge request in a mobile application on a remote device.

The step of processing payment may include processing payment using tokenized carbon credits.

The method may further include the step of tracking, with the electronic device, the electromagnetic energy that is supplied to the energy supply device in a peer-to-peer block.

A non-transitory computer readable medium that stores executable program code, which when executed by a computer performs the method according to any of the above paragraph(s).

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A wireless charging authentication and payment system, comprising:
an electronic device configured for wirelessly receiving electromagnetic energy in accordance with a charge request to charge a battery of the electronic device;
an energy supply device configured to supply the electromagnetic energy for wirelessly charging the electronic device according to the charge request; and
an electronic controller configured to receive the charge request and to transmit a charging command to the energy supply device to wirelessly supply the electromagnetic energy to the electronic device according to the charge request, and the electronic controller further is configured to process a payment for the electromagnetic energy that is supplied by the energy supply device and received by the electronic device for wirelessly charging the battery of the electronic device.

2. The wireless charging authentication and payment system of claim 1, wherein:
the electronic controller is a cloud server located remotely from the electronic device and the energy supply device;
the energy supply device includes an energy supply device wireless communication module;
the electronic device includes an electronic device wireless communication module; and
the energy supply device wireless communication module and the electronic device wireless communication module are configured to wirelessly communicate with the cloud server.

3. The wireless charging authentication and payment system according to claim 2, wherein the energy supply device wireless communication module and the electronic device wireless communication module are configured to wirelessly communicate with each other to pair the energy supply device with the electronic device.

4. The wireless charging authentication and payment system according to claim 1, wherein:
the energy supply device includes an energy supply device wireless communication module;
the electronic device includes and electronic device wireless communication module; and
the energy supply device wireless communication module and the electronic device wireless communication module are configured to wirelessly communicate with each other to pair the energy supply device with the electronic device.

5. The wireless charging authentication and payment system according to claim 1, wherein:
the energy supply device includes a power source configured to supply power and a transmitter pad configured to wirelessly transmit the supplied power as the electromagnetic energy to the electronic device; and
the electronic device includes a receiver pad configured to wirelessly receive the electromagnetic energy transmitted by the transmitter pad, and the battery stores the electromagnetic energy received by the receiver pad.

6. The wireless charging authentication and payment system according to claim 5, wherein:
the energy supply device includes a power controller configured to identify and control an amount of power being supplied by the power source; and
the electronic device includes a charge controller configured to identify and control an amount of power stored in the battery.

7. The wireless charging authentication and payment system according to claim 6, wherein the charge controller is configured to generate the charge request, and the electronic device is configured to communicate the charge request to the electronic controller.

8. The wireless charging authentication and payment system according to claim 1, wherein at least one of the energy supply device and the electronic device includes a user interface configured to receive the charge request from a user, and the at least one of the energy supply device and the electronic device is configured to communicate the charge request to the electronic controller.

9. The wireless charging authentication and payment system according to claim 2, wherein the energy supply device wireless communication module is configured to wirelessly receive the charging command from the cloud server.

10. The wireless charging authentication and payment system according to claim 9, further comprising a mobile application on a remote communication device configured to receive the charge request from a user and store the charge request in the cloud server.

11. The wireless charging authentication and payment system according to claim 1, wherein the electronic controller is configured to process the payment using tokenized carbon credits.

12. The wireless charging authentication and payment system according to claim 1, wherein the electronic controller is configured to track the electromagnetic energy that is supplied to the energy supply device and received by the electronic device in a peer-to-peer block chain system.

13. A method of wireless charging authentication and payment, the method comprising the steps of:
pairing an electronic device with an energy supply device;
generating a charge request for wirelessly supplying electromagnetic energy from the energy supply device to the electronic device to charge a battery of the electronic device;
receiving, by an electronic controller, the charge request;
transmitting a charging command, with the electronic controller, to the energy supply device to wirelessly supply the electromagnetic energy to the electronic device to charge the battery of the electronic device, according to the charge request;
identifying, with the electronic controller, when the charge request is satisfied;
commanding, with the electronic controller, the energy supply device to stop wirelessly supplying the electromagnetic energy to the electronic device when the charge request is satisfied; and
processing a payment, with the electronic controller, for the electromagnetic energy that is supplied by the energy supply device to charge the battery of the electronic device, according to the charge request.

14. The method according to claim 13, wherein the step of generating the charge request includes identifying how much power is stored in a battery of the electronic device.

15. The method according to claim 13, wherein the step of generating the charge request includes inputting the charge request in a user interface on the energy supply device.

16. The method according to claim 13, wherein the step of generating the charge request includes inputting the charge request in a user interface on the electronic device.

17. The method according to claim 13, wherein the step of generating the charge request includes inputting the charge request in a mobile application on a remote device.

18. The method according to claim 13, wherein the step of processing payment includes processing payment using tokenized carbon credits.

19. The method according to claim 13, further comprising the step of tracking, with the electronic device, the electromagnetic energy that is supplied to the energy supply device in a peer-to-peer block chain system.

20. A non-transitory computer readable medium that stores executable program code, which when executed by a computer performs the method according to claim 13.
